(19) United States
(12) Patent Application Publication
(10) Pub. No.: US 2005/0012003 A1
(43) Pub. Date: Jan. 20, 2005

(54) Hanger strips for mounting items

(76) Inventors: Trevor Jackson, Kirkland, OH (US); Brenda Riney, Springdale, AR (US)

Correspondence Address: CALFEE HALTER & GRISWOLD, LLP, 800 SUPERIOR AVENUE, SUITE 1400, CLEVELAND, OH, 44114, US

(21) Appl. No.: 10/833,676

(22) Filed: Apr. 28, 2004

Related U.S. Application Data
(60) Provisional application No. 60/465,996, filed on Apr. 28, 2003.

(51) Int. Cl. F16B 47/00

(52) U.S. Cl. 248/205.3; 248/309.1

(57) ABSTRACT

Hangers are provided for mounting a variety of items, such as, for example, paper items, objects, decorative lights, and seasonal décor items, on target surfaces, namely surfaces to which electrostatic materials are adherent, including surfaces such as smooth and non-porous surfaces, windows, mirrors, metal surfaces, glossy surfaces, and the like. The hangers comprise an electrostatic, or cling, material having at least one support member.

### CROSS REFERENCE TO RELATED APPLICATIONS

This application claims priority to U.S. Provisional Application No. 60/465,996, filed Apr. 28, 2003, which is incorporated herein by reference in its entirety.

### BACKGROUND OF THE INVENTION

The present invention provides devices and systems for mounting a variety of items, such as, for example, paper items, objects, decorative lights, and seasonal décor items, on surfaces to which electrostatic materials are adherent (“target surfaces”), including surfaces such as smooth and non-porous surfaces, windows, mirrors, metal surfaces, glossy surfaces, and the like.

Devices used in the art for mounting items, such as for mounting seasonal décor, such as lighting, garland, and other decorative objects, are limited to suction-applied clips, tapes, glues, and adhesives which are applied directly to the smooth surfaces or surrounding borders. Other methods of affixing decorative items include the use of nails, screws, and staples fixed to surfaces bordering the smooth surface to be decorated. Among other limitations, these various mounting methods and devices are untidy and may cause damage to the mounting surface. Accordingly, alternatives for mounting items are needed.

### SUMMARY OF THE INVENTION

Hangers are provided for mounting a variety of items, such as, for example, paper items, objects, decorative lights, and seasonal décor items, on target surfaces, namely surfaces to which electrostatic materials are adherent, including surfaces such as smooth and non-porous surfaces, windows, mirrors, metal surfaces, glossy surfaces, and the like. The hangers comprise an electrostatic, or cling, material having at least one support member. In some embodiments, the support member is configured to receive and retain, and optionally reversibly retain, a mounted item. The support members are, in some embodiments, in the form of slots, or tabs with cutouts. Tab cutouts may be in the form of slits, perforations or holes, or cut outs having elliptical, circular, or other geometric shapes. Tab support members optionally further comprise grasping ends. Grasping ends are extensions that are contiguous with or attached to the tabs and are useful for grasping the end of the tab in order to stabilize the tab for insertion or attachment of the item to be mounted. Slots may comprise one or more slits, perforations or holes, or cut outs having elliptical, circular, or other geometric shapes. Preferably, cutouts are of a size that is somewhat smaller than the mounted item to be received, and are of a shape that will accommodate and permit insertion of the mounted item. Slots and tabs may be adapted to receiving mounting clips or other devices or assemblies which are adapted to receive and retain a mounted item. Examples of mounting clips include hooks, snaps, clips, brackets, and other implements. One example of a mounting device is a flexible plastic clip that is adapted to grasp decorative light bulbs of various sizes. Another example is a metal or plastic hook.

In some embodiments, hangers may have only one support member. In other embodiments, hangers may have multiple support members. In embodiments having multiple support members, the support members may be arranged in a series along the length of the hanger. In alternate embodiments, the support members may be arranged either randomly, or in a predetermined pattern, such as a specific shape. An example of such an embodiment is a shape of a holiday item such as a tree or a pumpkin, which shape is formed in outline by the arrangement of multiple support members. In some embodiments the support members are all of the same size and are spaced apart at regular space intervals. In alternate embodiments, the multiple support members have different sizes or configurations.

The electrostatic material may be transparent or opaque, and may optionally be ornamented. Ornamentation may comprise decorative items, materials or colorants. In some embodiments, ornamentation may be embedded, suspended or otherwise dispersed within all or a portion of the electrostatic material. Ornamentation may also be on the surface of the electrostatic material, and may be either permanently or reversibly attached or adhered thereto,

The hangers are useful for mounting and displaying a variety of items. The hangers are advantageous as they are modular and can be adapted for use on any size surface. They are easy to use and do not require any additional means of attachment. In some embodiments, the hangers permit fixed and regular spacing of mounted items without need to measure. In other embodiments, the hangers allow user configured arrangement and fixation of mounted items. The hangers are reusable and they optionally permit the release and reuse of the decorative items without causing any damage or change to the decorative items or the mounting surface.

Also provided is a system for hanging items, particularly decorative items, comprising at least two or more strips of electrostatic material wherein each strip comprises at least one support member for receiving decorative items and wherein the at least two or more strips are mounted together on a target surface so as to permit attachment of one or a series of decorative items. Also provided are methods for hanging decorative items.

### DESCRIPTION OF THE DRAWINGS

FIG. 1 is a front view of one embodiment of a hanger strip, comprising multiple support members that are uniformly sized tabs with grasping ends and are arranged in series. Such an embodiment may be used for mounting decorative mini lights.

FIG. 2 is a front view of one embodiment of a hanger strip comprising multiple support members that are uniformly sized and spaced slots (two slits) and are arranged in series. Such an embodiment may be used for mounting strings or strands, such as for example, garland, beads, and the like,

FIG. 3 is a perspective view of decorative mini lights mounted on a window surface showing the detail of insertion of the mini light base into the elliptical cut out on the tab.

FIG. 4 is a perspective view of decorative mini lights mounted on a window surface with the electrical wires of the mini lights oriented away from the window frame.

FIG. 5 is a perspective view of a hanger strip with decorative decals affixed to the strip surface. This figure also shows decorative mini lights mounted on a window surface with the electrical wires of the mini lights oriented toward the window frame.

### DETAILED DESCRIPTION OF THE INVENTION

Hangers

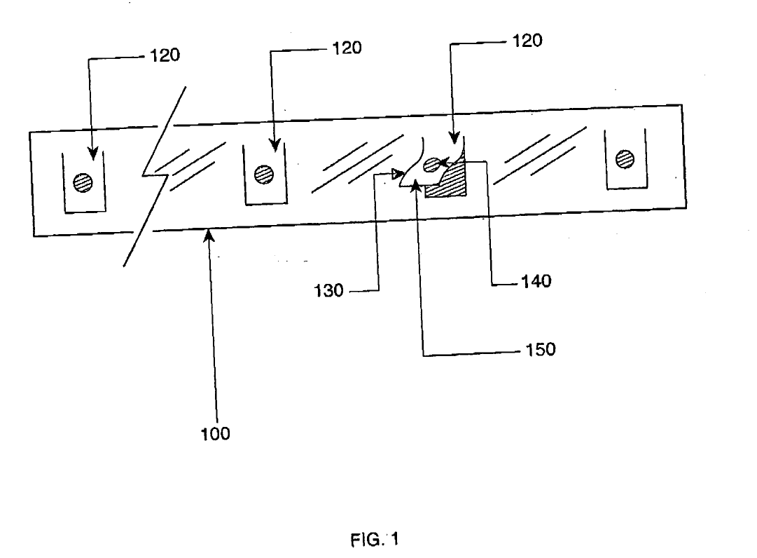

Referring to FIG. 1, the hangers 100 comprise flexible electrostatic material. The electrostatic material is sensitive and attractive static cling material with a flexible construction. The static cling material may be made from poly-vinyl chloride or from other materials having static sensitive properties, such as plastic, rubber, silicone, and other polymeric materials. Preferably, the electrostatic material is in the form of thin sheets or films, with ranges in thickness from about 0.1 to about 30 mil, and more preferably from about 6 to about 10 mil. In some embodiments, the static cling material is provided in the form of hanger 100 strips that vary in width from about 1 inch to about 10 inches, and in length from about 1 foot to about 100 feet. In other embodiments, the static cling material is provided in the form of sheets that vary in width from about 1 inch to about 100 feet, and in length from about 1 inch to about 100 feet. For applications to surfaces such as windows, hanger 100 width is from about 1 inch to about 4 inches, and the length is from about 1 foot to about 20 feet. The hangers 100 are ideally suited for use on surfaces of varying sizes. Selection of hanger 100 strip or sheet width is determined based on the decorative product to be mounted and the size of the target surface. As needed, the hangers 100 may be shortened or mounted in an end-to-end or overlapping fashion to accommodate the size of the target surface.

The hangers 100 may be provided in wound rolls, flat sheets or folded sheets. The rolls may be either tightly or loosely wound, and may optionally have a core such as a paper or wooden dowel. The sheets may be folded such as a ribbon. Optionally, the wound or folded hangers 100 may have a paper or plastic backing which is removed prior to mounting.

The hangers 100 are adapted to receive various items, such as décor items, and comprise a series of support members 120 that have been partially cut out. Each hanger 100 strip may have one or multiple support members. Spacing between the support members 120 is selected for optimal display of the item or items to be mounted. In some embodiments the spacing between support members 120 is fixed. In other embodiments, the spacing is random. Hangers may be provided that do not have any support members 120 such that the user can create support members 120 for custom use. For embodiments which comprise support members, spacing of support members 120 may be from about 0.001 inches to about 100 inches, or from about 1 to 10 inches, or any such other spacing as is appropriate for the size of the hanger 100 and the size and number of items to be mounted. For embodiments in which items are to be mounted on surfaces such as windows and mirrors, good results have been obtained with spacing between support members 120 of about 3 inches.

Support members may be tabs 130. An example of a hanger 100 with support members 120 in the form of tabs 130 is shown in FIG. 1; this hanger 100 is particularly well suited to receive decorative mini-lights. The length of the tabs 130 is likewise selected for optimal display of the mounted item. In some embodiments, tab 130 dimensions range from about 1 inch to about 3 inches in length and from about ¼ inch to about 1½ inches in width. For larger target surfaces, tabs 130 may have much larger dimensions on the order of several inches to feet. In certain other embodiments, tabs 130 may have smaller dimensions on the order of fractions of inches as appropriate to accommodate a variety of different mounting items. Bach tab 130 further comprises a cut-out 140 which is adapted to receive and retain at least a portion of the item to be mounted, or of an intermediate mounting device such as a clip, hook, snap, bracket, or the like. The further cut out may be in the form of one or more slits, holes or small perforations, or may be a single cut out that is elliptical, circular, square or in some other geometric shape. The size of cutouts 140 may be on the order of fractions of inches up to feet. In some embodiments, the ranges are from about 1/12 inch to about ¾ inches in either or both the vertical and horizontal dimensions or in diameter. In some embodiments, cutouts 140 are either slits 220 or ellipses and range from about 1/8 inch to ½ inch in length. Tabs 130 may optionally comprise a grasping end 150 to facilitate insertion of the decorative item. Grasping ends 150 130 are located at the distal end of the tab 130 relative to its attachment to the hanger 100 strip and range from about ¼ inch to about 1½ inches in length measured from the distal end of the cut out. Preferably, grasping ends 150 130 are about ½ inch in length. In other embodiments, the dimensions of grasping ends 150 130 may be in the range of fractions of inches, or in the range of multiple inches or feet.

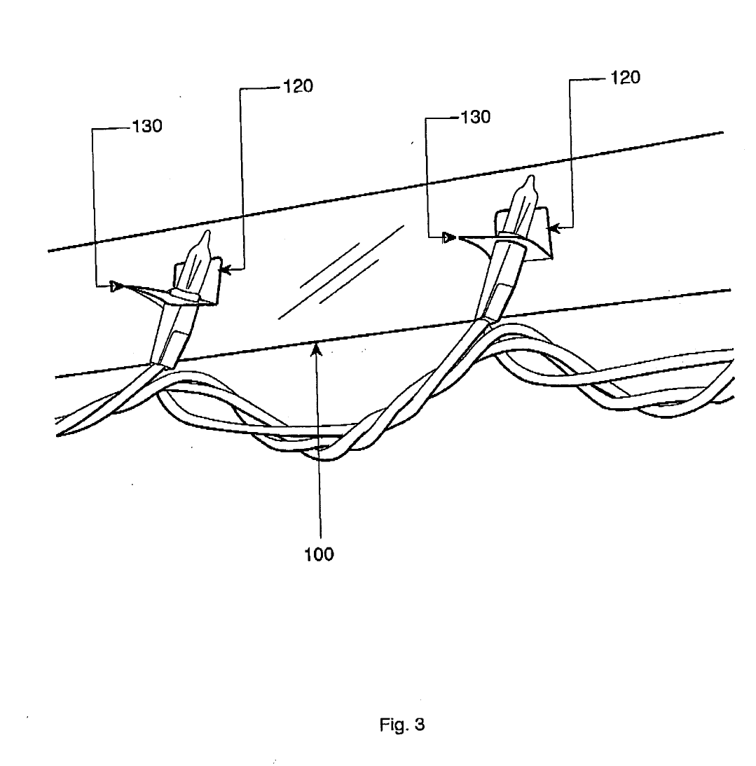

As shown in an embodiment illustrated in FIG. 3, for hanger 100 strips adapted to receive mini-lights, tabs 130 are spaced about 3 inches apart, tab 130 length is about 1½ inches and width is about ½ inch. The cutouts 140 are preferably elliptical in shape and are slightly smaller than the outer diameter of the standard circular mini light mounting base, and are about 1/4 inch in diameter. Grasping ends 150 130 are about 1/2 inch in length measured from the bottom of the cutout to the bottom of the tab.

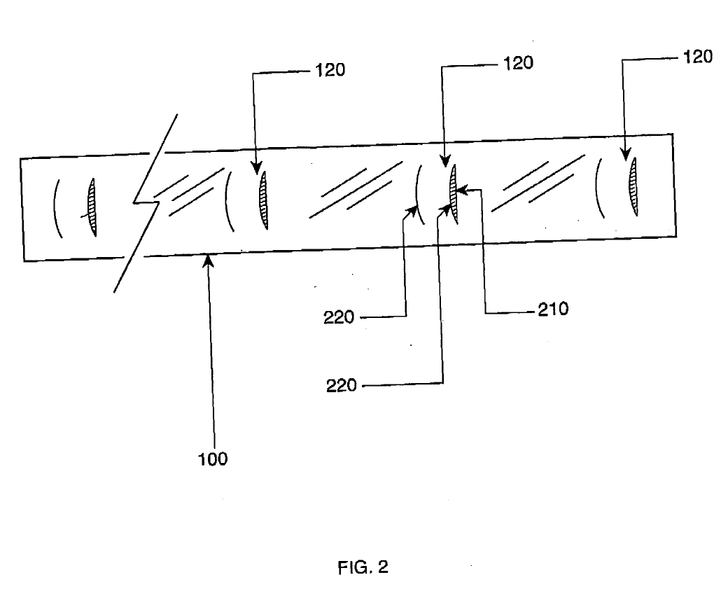

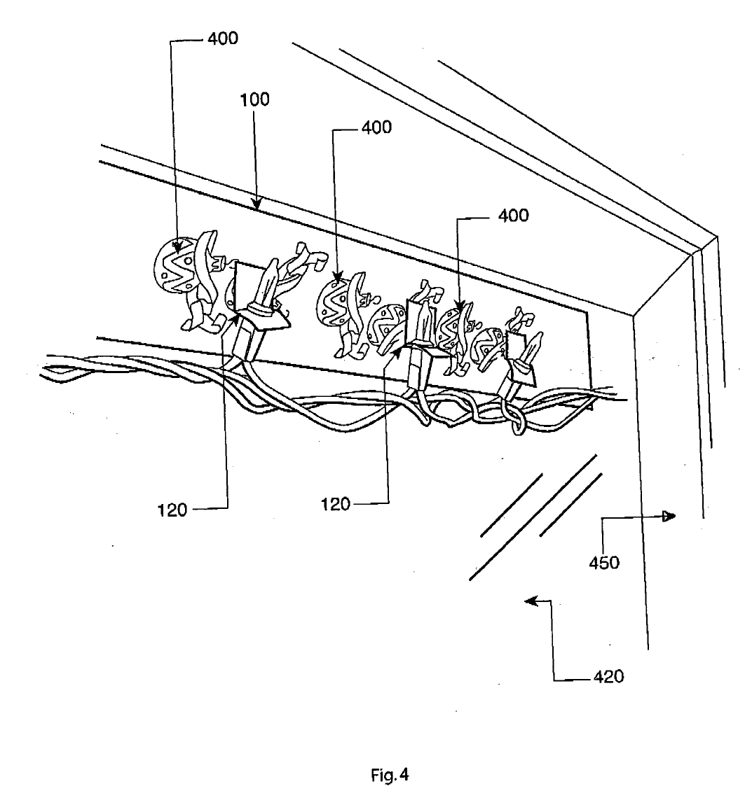

In another embodiment illustrated in FIG. 4, the hanger 100 strips comprise at least one slot 210 or a series of slots. An example of a hanger 100 with support members 120 in the form of a series of slots 210 is shown in FIG. 2; bis hanger 100 is well suite to receive garland. In the depicted embodiment, slots 210 are formed by a pairs of parallel slits 220 spaced apart by fixed distances. In some embodiments the size of a slot, i.e., the distance between the slits 220 that form the slot, ranges from about ½ inch to about 5 inches. In some embodiments, slots 210 range in length from about ½ inch to about 6 inches. Preferably, slots 210 are about 1 inch wide and about 1½ inches long. In other embodiments, the size of slots 210 may be on the order of fractions of inches or on the order of multiple inches to feet. Slot 210 size and spacing between slots 210 is selected for optimal display of the item to be mounted. Optionally, each slot 210 may also further comprise a cut-out 140 that is adapted to receive and retain a portion of the item to be mounted, or may receive and retain an additional item or other mounting means (not shown). The further cut out may be in the form of one or more slits, holes or small perforations, or may be a single cut out that is elliptical in shape, and ranges from about 1/12 inch to about ¾ inches in either or both the vertical and horizontal dimensions or in diameter. Preferably, cutouts are either slits or ellipses and range from about ⅛ inch to ½ inch in length. In some embodiments, cutout may have sizes in the range of fractions of inches to multiple inches or feet.

Hanger Ornamentation

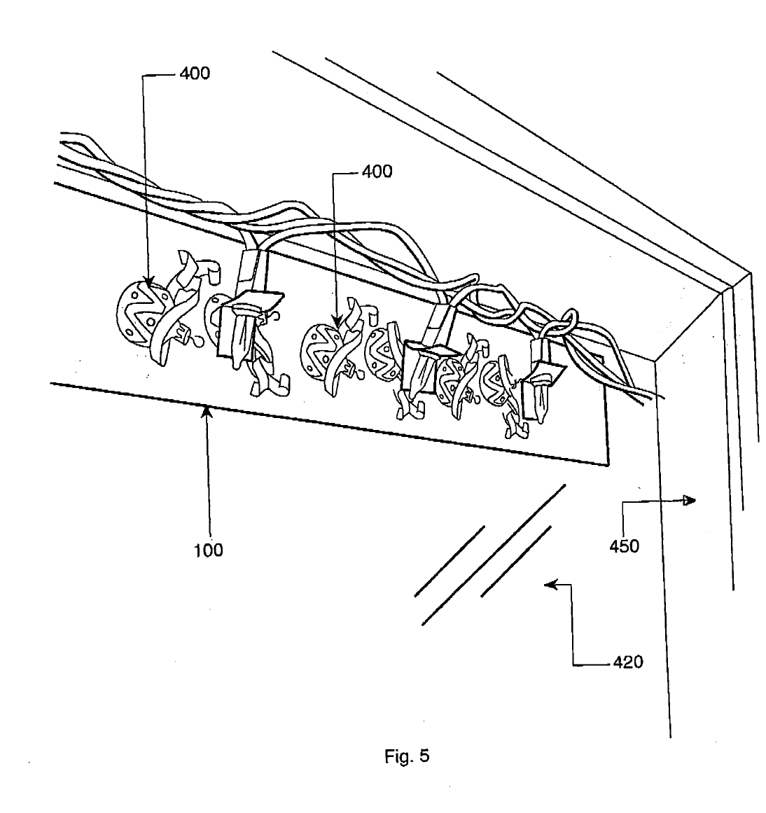

As shown in the embodiments illustrated in FIG. 4 and FIG. 5, the hangers 100 may optionally bear ornamentation 400 on the surface or embedded in the electrostatic material of the hanger 100. Ornamentation 400 may be added to the electrostatic material during preparation and may include colorants or suspended or embedded particles such as glitter, sequins, or other shapes or objects. Colorants may be single colors or mixtures, they may cause the electrostatic material to be opaque or transparent, and they may be patterned as in swirl or other patterns. Glitter and other suspended articles may likewise be distributed randomly or in a patterned fashion in the electrostatic material. Ornamentation 40 may also comprise depictions of festive scenes or items such as holiday ornaments, characters, foliage, including holly, bells, snowflakes, trees, stare, ornaments, greetings, names, dates, flowers, hearts, pumpkins, ghosts, and other seasonal and holiday subject matter, or other objects of interest, and may be affixed permanently or reversibly to the electrostatic material by painting, printing, or use of glues or adhesives. Ornamentation 400 may be affixed to hangers 100 by a variety of methods. Preferably, surface ornamentation 400 will not interfere with the electrostatic self-adhering properties of the electrostatic material. Surface ornamentation 400 may be achieved by printing, etching, or painting, on, or embedding within the electrostatic material, or between layers of electrostatic material, or through coatings, attachment of decals, or other means available.

Mounting

Hangers 100 are mounted on appropriate surfaces by electrostatic interaction between a target surface 420 and the hanger 100 cling material. Target surfaces 400 include glass such as found in windows, mirrors, doors, other smooth and non-porous surfaces, metal surfaces, surfaces of appliances and fixtures such as refrigerators and other appliances, and other areas or surfaces to which static cling materials will adhere. The hangers 100 are self-adhering in that no adhesives or other bonding materials are needed to achieve fixation to target surfaces 420. Hangers may be removably attached to target surfaces 420, and may optionally be reattached and reused.

Hangers 100 may be hung in any orientation on a target surface 420 to achieve the desired effect with the article or articles being mounted. For example, referring to FIG. 4 and FIG. 5, to achieve a border effect around a target surface 420 such as a window using mini lights, hangers 100 may be mounted parallel to the frame of the window 450 and the lights may be mounted such that the light wires are oriented either away from (as shown in FIG. 5) or toward (as shown in FIG. 4) the window frame 450. Hangers 100 may be cut using a knife, punch, scissors or other cutting tool to desired lengths for the desired fit to the target surface 420. To ensure proper attachment of the hangers 100 to the target surface 420, the target surface 420 should be cleaned and free of oils and dust and particulates. For best results, vertical hangers 100 should be mounted first, then horizontal hangers 100 should be mounted with the ends overlapping the ends of the vertical hangers 100. In embodiments where hangers 100 are in the form of strips for mounting on windows or similar target surfaces 420, the hangers 100 may be placed directly against the edge of the window frame or window edge, or at some other desired distance. Multiple hangers 100 may be placed parallel to each other. In one such embodiment, the hangers 100 may be used for mounting multiple light stands of one or many colors. Strips or sheets of hangers 100 may be mounted to cover all or a portion of a target surface. Support members 120 may be positioned on such strips to create an outline of a shapes, such as snowman, a wreath, bells, words, or other holiday or them image or greeting. Hangers 100 may be mounted to target surfaces 420 in other configurations. For example, several hangers 100 may be mounted to cover all or most of a target surface 420, such as a window or a mirror. Once the hangers 100 are mounted, the items to be mounted are affixed to the support members 120. In some embodiments, items may be pre-mounted on support members 120 or attached mounting means such that when the hangers 100 are attached to the target surfaces 420, no further mounting of displayed items is required. Décor items that can be mounted using the hangers 100 include lighting and garland, greeting cards, ornaments, and other decorative items. More generally, mounted items can vary based on the desires or needs of the user, and may be limited only by the size and load bearing limitations of the hangers 100.

Hangers 100 and support members 120 may be used to grip hooks, clips and other mounting devices to target surfaces 420. This type of mounting may be achieved by determining the number of mounting devices to be used on a target surface 420 and selecting or cutting a length of electrostatic material appropriate to cover the surface. The electrostatic material may be attached to the target surface 420 then the mounting devices may be slipped under the edge of the cling material of the hanger 100 so as to secure the mounting devices to the target surface 420. Alternatively, the mounting device may be temporarily positioned on the target surface 420 and the cling material of the hanger 100 may then be applied to the target surface over the device so as to secure it to the target surge 420. Care should be taken to ensure that the hook, or clip or other means for attaching the mounted item is accessible after being secured to the target surface 420. Alternatively, the electrostatic material of the hanger 100 may be pierced using a sharp tool or the like or using the mounting device to permit the device to grasp the electrostatic material. This may be done either before or after the electrostatic material is attached to the target surface 420.

### EXAMPLES

### Example 1

### Example 1

### Mounting Mini Lights on a Window

Holiday mini lights were hung on a window using hanger 100 strips that were 3 feet in length about 2 inches wide, having tabs 130 of about 1½ inches long, ½ inches wide, spaced 3 inches apart, and having grip tabs 130 of about ½ inches in length and cutouts 140 of about ¼ inch in diameter, according to the following instructions:

Clean window thoroughly. (Be sure to clean all the way out to the edges and corners)

Take roll of static hanger 100 and start at one corner. Roll out length to fit one edge of window. It is best to lay the two vertical strips first. (Be sure to keep the static hanger 100 clean while applying)

Cut the static hanger 100 with scissors to proper length.

Using a soft cloth, rub surface of static hanger, pressing it firmly to the window surface. (It is very important to be sure the static hanger 100 is completely adhered to the window)

Continue with applying the next edge of the window following steps 2-4, until the entire window border has been framed. (Remember, it is best to lay the two vertical strips first).

Uncoil light string and have it placed on the floor directly under the window.

To place lights into the static hanger, you will need to use a blunt object (like a butter knife) to lift the edge of the tabs 130.

Start with end of light string (Not with plug). Use one of the lower corners (Closest to wall outlet).

Lift the first tab 130 with the butter knife. Place the tip of the mini light into the light socket hole on the tab 130 and grasp and pull on the tab 130 grip until the hole in the tab 130 stretches over the base of the mini light. (Be very careful not to pull the static hanger 100 from the window. If the static hanger 100 does come away from the window, use a soft cloth and rub it back down into place)

Keep supporting the light string, and move vertical to the next light socket, and continue steps 7-9 until you have worked around entire window.

You can use a twist tie to hold the excess amount of light string.

You have now successfully installed your Static Cling Window Light Hanger.

1. A hanger comprising an electrostatic material comprising at least one support member for securing items to target surfaces.

2. The hanger according to claim 1, wherein the at least one support member is selected from the group consisting of a slot, and a tab comprising a cutout.

3. The hanger according to claim 1, wherein the electrostatic material comprises ornamentation selected from the group consisting of decorative items suspended in the electrostatic material and surface ornamentation.

4. The hanger according to claim 2, comprising two or more support members.

5. The hanger according to claim 4, comprising three or more support members.

6. The hanger according to claim 5, wherein the three or more support members are arranged in a linear pattern.

7. The hanger according to claim 5, wherein the three or more support members are arranged in a non-linear pattern.

8. The hanger according to claim 5, wherein the three or more support members are arranged in a decorative pattern.

9. The hanger according to claim 1, comprising a mounting device.

10. A hanger comprising:
a strip or sheet electrostatic material which is capable of self-adhering to a target surface;
at least one support member which is integral with the strip or sheet of electrostatic material.

11. A hanger according to claim 10, wherein the at least one support member is selected from the group consisting of a slot, and a tab comprising a cutout.

12. The hanger according to claim 11, wherein the tab comprises a grasping tab.

13. A hanger according to claim 10, comprising at least two support members spaced at regular intervals along at least one dimension of the hanger.

14. A hanger according to claim 10, wherein the electrostatic material is transparent.

15. A hanger according to claim 10, wherein the electrostatic material is opaque.

16. A hanger according to claim 10, wherein the electrostatic material comprises ornamentation in the form of decorative materials, objects, or colorants.

17. A hanger according to claim 10, wherein the electrostatic material includes surface ornamentation.

18. A hanger comprising:
an electrostatic material which is capable of self-adhering to a target surface;
at least one support member which is integral with the electrostatic material, and wherein the support member is selected from the group consisting of a slot, and a tab comprising a cutout and a grasping tab
wherein the electrostatic material comprises ornamentation in the form of decorative materials, objects, or colorants.

19. A hanger according to claim 18, wherein the electrostatic material is transparent.

20. A hanger according to claim 18, wherein the electrostatic material is opaque.

21. A hanger system comprising:
at least two strips or sheets of electrostatic material that is capable of self-adhering to a target surface;
at least one support member on each of said at least two strips or sheets of electrostatic material,
wherein the at least two strips or sheets of electrostatic material are mounted together on a target surface so as to permit attachment of one or more items.

22. A method for hanging an item comprising:
positioning at least one strip or sheet of electrostatic material which is capable of self-adhering to a target surface at a desired location relative to the target surface and affixing the electrostatic material to the target surface; and
attaching the item to the at least one strip or sheet of electrostatic material using an attachment means such that the item is effectively mounted on the target surface.

23. The method according to claim 18, wherein the attachment means is selected from the group consisting of a slot, a tab comprising a cutout, and a mounting device.

24. A method for hanging an item comprising:
providing an electrostatic material which is capable of self-adhering to a target surface;
providing a mounting device for hooking or grasping an item wherein the mounting device comprises a fixation portion for connecting to the at least one strip or sheet of electrostatic material, and a holder portion for hooking or grasping an item;
attaching the electrostatic material to the target surface;
fixing the mounting device on to the electrostatic material either before or after the electrostatic material is mounted to the target surface; and
attaching the item to the mounting device such that the item is effectively mounted on the target surface.

25. The method for hanging an item according to claim 24, wherein the mounting device is fixed to the electrostatic material by positioning the mounting device at a desired location relative to the target surface and affixing the electrostatic material over the mounting device and securing the electrostatic material to the target surface such that the mounting device is secured under the electrostatic material and is accessible for receiving the item.
